(19) United States
(12) Patent Application Publication
(10) Pub. No.: US 2011/0217426 A1
(43) Pub. Date: Sep. 8, 2011

(54) ENTERIC COATING COMPOSITION

(76) Inventors: STEPHEN C. PERRY, NORWOOD, MA (US); JACK M. WATKINS, OAKDALE, CA (US)

(21) Appl. No.: 12/717,942

(22) Filed: Mar. 4, 2010

(51) Int. Cl. A23L 1/30

(52) U.S. Cl. 426/103; 426/648

(57) ABSTRACT

Compositions and methods are described that promote health and increase a shelf-life of foods. The compositions may feature mixtures of fatty acids, vegetable gums, and oligosaccharides. When introduced into a food article, the compositions can act as a protective barrier for micronutrients, phytochemicals, and nutraceuticals such as may be found in food products, for example food additives, as the food products are stored and as the food products are being digested. The compositions can stabilize food products during prolonged storage and as ingested food products move through the digestive tract so that nutrients are available for absorption in a consumer's intestines. Methods for producing food additives using the compositions are also described.

### FIELD OF THE INVENTION

The invention relates generally to methods of improving health and nutrition. In particular, embodiments of the present invention relate to compositions and methods increasing the shelf-life of food articles and for stabilizing micronutrients, phytochemicals, nutraceuticals, and other beneficial compounds in food additives and food articles for enteric digestion and absorption rather than digestion in the stomach.

### BACKGROUND

Society has become increasingly aware of the importance of maintaining proper nutritional habits. As the average diet increasingly utilizes processed foods, it has become more important for processed foods to provide the same good nutritional benefits of natural foods.

Nutrients necessary to support life include proteins, carbohydrates, fats, minerals, and vitamins. Processed food products are often supplemented by the addition of synthetic nutrients to help replace natural nutrients that may have been rendered inactive or otherwise damaged during processing of the food product. Elevated temperatures during cooking, for example, may damage the natural nutrients that are present in foods. The freeze drying process by which food products are dehydrated also may damage the natural nutrients that are present in foods.

Besides nutrients, other non-nutritive compounds found in, for example, fruits and vegetables may have beneficial effects when consumed. Nutraceuticals, for example, are chemical compounds in foods that may aid in preventing or treating diseases and other medical conditions when consumed even though they are not traditionally recognized to possess nutritive value.

Phytochemicals are chemical compounds in plants that also may aid in preventing or treating diseases and other medical conditions when consumed even though they also are not traditionally recognized to possess nutritive value. Nutraceuticals and phytochemicals, like nutrients, may be damaged by subsequent processing of food products to which they are added.

Heating processes for stabilizing and preserving nutrients, particularly phytochemicals, that involve application of a colloid plant extract selected from vegetable gums, hydroscopic phosphatides, vegetable albumin, and pectin are not entirely satisfactory from the standpoint of maintaining the nutritional value of the original foodstuffs, since a relatively large percentage of the nutritional value still may be lost during subsequent processing.

Conventional nutraceutical and phytochemical food additives are often ineffective in promoting good health and nutrition because they are digested in the stomach, which effectively breaks down the additives into compounds that provide less advantage to the body from a health and nutrition viewpoint. The highly acidic conditions present in the stomach prevent many nutraceutical and phytochemical food additives from reaching the intestines, and particularly the small intestine, where the additives may be absorbed for use by the body to provide a nutritional benefit to the consumer.

### SUMMARY

The invention relates to compositions and methods that promote health and increase the shelf-life of foods. The compositions can include mixtures of fatty acids, vegetable gums, and oligosaccharides. When compounded with a food article, the compositions can act as a protective barrier for micronutrients, phytochemicals, and nutraceuticals such as may be found in food products, for example food additives, as the food products are stored and as the food products are being digested. The compositions can stabilize food products during prolonged storage and as ingested food products move through the digestive tract so that nutrients are available for absorption in a consumer's intestines. Methods for producing food additives using the compositions are also described.

What is needed is a composition that stabilizes and protects micronutrients, phytochemicals, nutraceuticals, and other beneficial compounds in food additives and food articles from degradation during processing.

Therefore, in accordance with a feature of an embodiment of the present invention, there is provided a composition for stabilizing and protecting micronutrients, phytochemicals, nutraceuticals, and other beneficial compounds in food additives and food articles. The composition may comprise a mixture of vegetable gums, oligosaccharides, and at least one fatty acid.

In accordance with still another embodiment of the present invention there is provided a process for producing a food additive. A food article may be chopped or granulated; sprayed with a mixture of vegetable gums, oligosaccharides, and fatty acid; and then freeze dried to provide a stabilized freeze dried food article suitable for subsequent processing into a food additive, for example by grinding into a powder.

Still further features and advantages of the present invention are identified in the ensuing description.

Accordingly, the invention features a composition for improving health and nutrition. The composition can feature an enteric coating that includes a fatty acid, an oligosaccharide, and a vegetable gum.

In another aspect, the invention can feature the fatty acid including at least one fatty acid selected from among: oleic acid, lauric acid, linoleic acid, palmitoleic acid, caprylic acid, capric acid, myristic acid, palmitic acid, margaric acid, margaroleic acid, stearic acid, alpha-linoleic acid, arachidic acid, eicosanic acid, behenic acid, erucic acid, and combinations and mixtures thereof.

In another aspect, the invention can feature the fatty acid being oleic acid.

In another aspect, the invention can feature the oligosaccharide including at least one oligosaccharide selected from among: a fructo-oligosaccharide, a galacto-oligosaccharide, an inulin, and combinations and mixtures thereof.

In another aspect, the invention can feature the vegetable gum including at least one vegetable gum selected from among: konjac root extract, gellan, xanthan, carrageenan, and combinations and mixtures thereof.

In another aspect, the invention can feature the vegetable gum being a natural vegetable gum, a modified vegetable gum, or combinations and mixtures thereof.

In another aspect, the invention can feature the natural vegetable gum being at least one gum selected from among: gum arabic, guar gum, agar, carrageenan gum, karaya gum, gum ghatti, locust agar, algin, pectin, xanthan gum, locust bean gum, gum tragacanth, tamarind gum, and combinations and mixtures thereof.

In another aspect, the invention can feature the modified vegetable gum being at least one gum selected from among: chelated agar; a pectin derivative; low-methoxyl pectin; high-methoxyl pectin; an alginate; a cellulose derivative; microcrystalline cellulose; methylcellulose; sodium carboxymethyl cellulose; carboxymethylcellulose; hydroxypropyl cellulose; hydroxypropyl methyl cellulose; sodium hydroxymethyl cellulose; carboxymethyl locust bean gum; gellan gum; carboxymethyl guar gum; and combinations and mixtures thereof.

In another aspect, the invention can feature the alginate being propylene glycol alginate.

In another aspect, the invention can feature the enteric coating including at least one soluble anionic fiber selected from among: all forms of alginates, pectin, carrageenan, polygeenan, and gellan including protonated and salt forms; protonated alginic acid; and salts of alginic acid.

A method of the invention can be used for stabilizing and protecting a food additive to enhance enteric nutrient absorption. The method can include the step of applying to the food additive an enteric coating composition that features a fatty acid, an oligosaccharide, and a vegetable gum.

Another method of the invention can be used for producing an enterically coated food article. The method can include the step of coating a food article with an enteric coating composition that is resistant to break down at a pH of 1 but begins to break down at a pH of greater than 7.

Another method of the invention can include the food article being a fruit or vegetable.

Another method of the invention can be used for producing a food additive for improving the shelf-life of a food article. The method can include the steps of: (a) shredding a first food article; (b) sanitizing the first food article; (c) applying to the first food article a composition featuring a fatty acid, an oligosaccharide, and a vegetable gum; (d) freeze drying the first food article; and (e) grinding the first food article into a powder to form a food additive.

Another method of the invention can include the step of applying the food additive to a second food article.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents and other references mentioned herein are incorporated by reference in their entirety. In the case of conflict, the present specification, including definitions will control.

### BRIEF DESCRIPTION OF THE DRAWINGS

FIG. 1 is a graph showing the dissolution profiles for sodium ascorbate tablets using waxy cornstarch as an enteric coating.

FIG. 2 is a graph showing, for purposes of comparison with the results of testing shown in FIG. 1, the dissolution profiles for sodium ascorbate tablets using whey-derived lactose as an enteric coating

### DETAILED DESCRIPTION

The invention provides compositions for coating a food article to preserve nutrients in the food article for enteric absorption. These compositions improve health and nutrition of consumers. These compositions can also be added to a food article to increase the food article's shelf-life.

As used throughout this description, “nutrients” can refer to compounds generally recognized as necessary to support human life. These compounds can include proteins, carbohydrates, fats, minerals, and vitamins. Mineral and vitamins, because they are generally required in much smaller amounts than the other nutrients, may be referred to as “micronutrients.”

“Nutraceuticals,” as used herein, can refer to non-nutritive compounds that nonetheless may produce beneficial effects, for example medicinal effects, when consumed. Exemplary nutraceuticals include, but are not limited to, phytochemicals, glucosamine, methylsulfonylmethane, chondroitin, ruscus, bromlein, boswellin, carnitine, hydroxycitric acid, chitosan, acetyl-L-carnitine, phosphatidylserine, huperzine-A, S-adenosylmethione, vinceptine, dimethylaminoethanol (DMAE), lecithins, ginseng, ashwagandha, ipriflavone, NADH, magnesium malate, and D-ribose. “Nutraceuticals” also include as yet unknown or unidentified compounds that may produce beneficial effects when consumed.

“Phytochemicals,” as used herein, can refer to non-nutritive plant chemicals that nonetheless may produce beneficial effects when consumed. For example, some phytochemicals have been implicated as anti-cancer compounds or may possess other medicinal qualities. Exemplary phytochemicals include, but are not limited to, ajoene, allyl sulfides, beta-carotene, butyl phthalide, calcium pectate, capsaicin, carotenoids, catechin hydrate, coumarin, coumesterol, ellagic acid, flavonoids and isoflavones such as quercetin, genistein, gingerols, glycyrrhizin catechins, heliotropin, indoles and glucosinolates, isothiocyanates and thiocyanates, kaempferol, lutein, lycopene, monoterpenes such as limonene, para-coumaric acid, phenols, phthalides, phytic acid, polyacetylenes, quercetin, saponin, silymarin, sulfaforaphane, thiols, and zeaxanthin. “Phytochemicals” also include as yet unknown or unidentified plant chemicals that may produce beneficial effects when consumed.

In one embodiment, the composition can feature an enteric coating. The enteric coating can include a fatty acid, an oligosaccharide, and a vegetable gum. The fatty acid can be selected from among: oleic acid, lauric acid, linoleic acid, palmitoleic acid, caprylic acid, capric acid, myristic acid, palmitic acid, margaric acid, margaroleic acid, stearic acid, alpha-linoleic acid, arachidic acid, eicosanic acid, behenic acid, erucic acid, and combinations and mixtures thereof. In an exemplary embodiment, the fatty acid can be oleic acid.

The oligosaccharide of the composition can be selected from among: a fructo-oligosaccharide, a galacto-oligosaccharide, an inulin, and combinations and mixtures thereof. The composition can include one or more inulins, as well as the methods for producing such inulins, such as, for example, those described in U.S. Pat. No. 6,203,797, which is incorporated herein by reference.

The vegetable gum can be selected from among: konjac root extract, gellan, xanthan, carrageenan, and combinations and mixtures thereof. The vegetable gum can also be either a natural vegetable gum, a modified vegetable gum, or combinations and mixtures thereof.

In embodiments in which a natural gum is selected as an ingredient of the composition, the natural vegetable gum can be selected from among: gum arabic, guar gum, agar, carrageenan gum, karaya gum, gum ghatti, locust agar, algin, pectin, xanthan gum, locust bean gum, gum tragacanth, tamarind gum, and combinations and mixtures thereof.

In embodiments in which a modified gum is selected as an ingredient of the composition, the modified gum can be selected from among: a chelated agar; a pectin derivative; low-methoxyl pectin; high-methoxyl pectin; an alginate; a cellulose derivative; microcrystalline cellulose; methylcellulose; sodium carboxymethyl cellulose; carboxymethylcellulose; hydroxypropyl cellulose; hydroxypropyl methyl cellulose; sodium hydroxymethyl cellulose; carboxymethyl locust bean gum; gellan gum; carboxymethyl guar gum; and combinations and mixtures thereof. In an exemplary embodiment, the alginate can be propylene glycol alginate.

In an embodiment of the invention, there is provided a composition for stabilizing and protecting micronutrients, phytochemicals, nutraceuticals, and other beneficial compounds in food additives and food articles. The composition may include vegetable gums, oligosaccharides, and at least one fatty acid. An exemplary use of the composition is to protect micronutrients, phytochemicals, nutraceuticals, and other beneficial compounds in food additives and articles from degradation when subjected to low or high temperatures.

Any applicable vegetable gum may be used in the composition, following the guidelines provided herein. Vegetable gums contemplated for use in the invention include, but are not limited to, the following: gum arabic (acacia gum), guar gum (guar flour), agar (agar-agar), carrageenan gum (alpha, kappa and all other types), karaya gum (sterculia gum, India tragacanth, kadaya gum), gum ghatti, locust agar, algin, pectin, xanthan gum, locust bean gum, gum tragacanth, tamarind gum, and combinations and mixtures thereof. Additionally, modified vegetable gums may be used in accordance with the present invention. Modified vegetable gums contemplated for use in the invention include, but are not limited to, the following: chelated agar; pectin derivatives including both low- and high-methoxyl pectin; alginates such as propylene glycol alginate; cellulose derivatives such as microcrystalline cellulose, methylcellulose, sodium carboxymethyl cellulose, carboxymethylcellulose, hydroxypropyl cellulose, hydroxypropyl methyl cellulose, and sodium hydroxymethyl cellulose; carboxymethyl locust bean gum; gellan gum; carboxymethyl guar gum; and combinations and mixtures thereof.

In one exemplary embodiment, the vegetable gum is gellan gum. Gellan gum is a polysaccharide of repeating tetrasaccharide units. Each tetrasaccharide unit has two glucose residues, one glucuronic acid, and one rhamnose residue. Additionally, the tetrasaccharide units may be substituted with acyl (glyceryl and acetyl) groups at the O-glycosidically-linked esters. Gellan gum is commonly obtained from fermentation of a carbohydrate by the bacteria Pseudomonas elodea, although gellan gum obtained from other sources also is applicable in the invention.

In another exemplary embodiment, the vegetable gum is xanthan gum. Xanthan gum is a polysaccharide composed of glucose, mannose, and glucuronic acid and has a backbone similar to the backbone of cellulose but with additional trisaccharide sidechains. Xanthan gum is commonly used in food products to control viscosity because of its hydration and gelling capabilities. Additionally, its relatively good hydration ability at low temperatures may make xanthan gum useful in hindering ice recrystallization in freeze-thaw situations. Xanthan gum is commonly obtained from fermentation of corn sugar by the bacteria Xanthomonas campestris, although gellan gum obtained from other sources also is applicable in the invention.

In yet another exemplary embodiment, the vegetable gum is carrageenan gum. “Carrageenan” refers collectively to a group of polysaccharides consisting of long chains of galactose derivatives obtained by alkaline extraction from red seaweed, commonly of the genus Chondrus, Eucheuma, Gigartina and Iridaea. The three most common carrageenan gums (i.e., κ-carrageenan, ι-carrageenan, and λ-carrageenan) are commonly used as gels and thickeners in food products.

In a preferred embodiment, the composition can include about 1% to about 50% vegetable gums. In a more preferred embodiment, the composition can include about 1% to about 25% vegetable gums. In a most preferred embodiment, the composition can include about 1% to about 10% by weight vegetable gums.

Any applicable oligosaccharides may be used in the composition, following the guidelines provided herein. Oligosaccharides are short chains of sugar molecules. Common oligosaccharides include fructo-oligosaccharides (FOS), galacto-oligosaccharides (GOS), and inulins. Vegetables are common sources of oligosaccharides, though oligosaccharides obtained from other sources also are contemplated for use in the invention.

In a preferred embodiment, the composition can include about 5% to about 45% by weight oligosaccharides. In a more preferred embodiment, the composition can include about 5% to about 25% by weight oligosaccharides. In a most preferred embodiment, the composition can include about 5% to about 10% by weight oligosaccharides.

Application of the composition to a food additive or food article may act as a protective barrier at the molecular level to increase the temperature resistant qualities of the food additive or article, particularly the temperature resistant qualities of micronutrients, phytochemicals, and nutraceuticals that may be present in the food additive or article. For example, addition of the composition may help a food additive or article to withstand the 150° F. to 180° F. temperature changes commonly associated with the freeze drying process. Food additives and articles treated with the natural composition may experience less degradation of their natural nutritional and extra-nutritional content when cooked or frozen by consumers and manufacturers. Application of the natural composition, therefore, may help to reduce reliance upon synthetic nutritional supplements in processed food products. Additionally, application of the natural composition may increase the shelf life of treated food additives and articles.

In another embodiment, there is provided a process for preparing a food additive. A food article may be shredded and sanitized. A composition comprising vegetable gums, oligosaccharides, and at least one fatty acid as described herein may be applied to the food article. The food article may be freeze dried and ground into a powder. A stabilizing composition optionally may be applied to the powder. The food additive may be mixed with processed foods to enhance the nutritional and extra-nutritional content of the food.

The food article may be any applicable raw material useful as a food additive, as will be appreciated by one skilled in the art. Raw fruits and vegetables, for example, are contemplated as food articles. Phytochemical-rich foods are preferred food articles. Phytochemical-rich foods include, but are not limited to, tomatoes, broccoli, garlic, Brussels sprouts, cabbage, bok choi, and other cruciferous vegetables. Additionally, fruit such as apples and oranges are useful as food articles. The raw fruits and vegetables preferably may be selected, for example, to ensure freshness and stored at reduced temperatures. The food articles may be shredded to a particle size of about 6.2 mm (0.25 inches). Preferably, the food article may be shredded to a particle size of about 3.2 mm (0.125 inches). If desired, the shredded food articles may be selected by weight.

A mixture of vegetable gums, oligosaccharides, and at least one fatty acid as described herein may be applied to the food article, for example by dusting or spraying. The mixture may help to prevent degradation of nutraceuticals and phytochemicals present in the food article during subsequent processing, for example freeze drying. Preferably, the vegetable gum is selected from gellan, xanthan, carrageenan, and combinations and mixtures thereof. A mixture of about 1% to about 50% by weight vegetable gums, about 5% to about 45% by weight oligosaccharides, and about 1% to about 20% by weight fatty acid is preferred. A mixture of about 1% to about 25% by weight vegetable gums, about 5% to about 25% by weight oligosaccharides, and about 5% to about 15% by weight fatty acid is more preferred. A mixture of about 1% to about 10% by weight vegetable gums, about 5% to about 10% by weight oligosaccharides, and about 5% to about 10% by weight fatty acid is most preferred. The mixture may be applied in a liquid form or a dry powdered form. It may be preferable to apply the mixture in a temperature controlled manner so as to maximize the adhesion between the mixture and the food article. Also, it may be preferable to mix the vegetable gum and oligosaccharide components first, thereby forming a sticky product, and then add the fatty acid to the sticky product and mix until homogenous.

The food article may be freeze dried to reduce the moisture content of the article. Freeze drying may proceed in any applicable manner, as will be appreciated by one skilled in the art. In an exemplary embodiment, the food article may be cooled to about 0° C. (32° F.) before being introduced to a rotary type freeze dryer. After introduction of the food article, the pressure in the freeze dryer may be reduced to about 500 microns of Hg (0.5 torr), which may aid in removing moisture from the food article. The evaporation of water from the food article due to the low pressure in the freeze dryer may further reduce the temperature of the food article, for example, to about −18° C. (0° F.). The low pressure may be maintained for about 8 to about 12 hours. Thereafter, the temperature of the freeze dryer may be allowed to increase to about 30° C. (86° F.). Freeze drying the food article may preferably reduce the moisture content, which is typically about 85% before freeze drying, to within the range of about 2% to about 5%.

The food article may be ground to a powder. Preferably, the size of the powder is about 60 mesh to about 100 mesh. The mesh size of the powder may be determined by sifting the powder through a screen with appropriately sized orifices. A sifting process also may be used to separate powders of different sizes in order to obtain a powder of a desired mesh size. A stabilizing composition may optionally be added to the food article. The stabilizing composition, if used, may help to further prevent degradation of micronutrients, nutraceuticals, and phytochemicals present in the food article during subsequent processes, for example cooking. In a preferred embodiment, a stabilizing composition comprising a second mixture of vegetable gums, oligosaccharides, and at least one fatty acid as described herein is added to the food article.

The food additives made according to this process may exhibit superior resistance to degradation and deactivation of constituent nutraceuticals, phytochemicals, and micronutrients during subsequent processing of food products supplemented with the food additives. For example, the phytochemicals of the food additives made according to this process may resist temperatures up to about 80° C. (180° F.). More preferably, food additives made according to this process may maintain 97% of their natural nutritional content at temperatures up to 205° C. (400° F.).

The invention now will be described in more detail with reference to the following non-limiting example.

### Example 1

Tests were conducted using the composition which determined that vegetable gums containing polysaccharides such as, for example, oligosaccharides, are preferred for inclusion in the composition over saccharides such as, for example, lactose. In these tests, sodium ascorbate, a freely water-soluble compound, was used as a detectable marker. Microcrystalline cellulose (“MCC”) and waxy cornstarch were used as the excipients in a first set of tablets. In a second set of tablets, lactose monohydrate was used as a reference cofiller instead of the waxy cornstarch. Lactose is the primary saccharide complex found in whey protein materials. Purified water was used as a granulation liquid in these tests.

Preparation of Tablets

As ingredients, the first set of tablets contained: 0.1% sodium ascorbate; 70.6% microcrystalline cellulose; and 29.3% waxy cornstarch. The second set of tablets contained: 0.1% sodium ascorbate; 70.6% microcrystalline cellulose; and 29.3% lactose.

Each set of tablets was made using the extrusion/spheronization technique using a mixer/granulator, an extruder, and a spheronizer. The tablets were prepared in batches of 2.5 kg. The speed of the powder feeder was 35 rpm and the speed of the liquid input pump was 195 rpm for formulation I (i.e., the first set of tablets) and 158 rpm for formulation II (i.e., the second set of tablets). The spheronization times for formulations I and II were 6 minutes and 2 minutes, respectively. The tablets were dried for 24 hours at ambient temperature.

Dissolution Tests

In vitro release tests were performed using a USP (U.S.A. Pharmacopoeia, 1995) apparatus I (basket method). The dissolution medium was 500 mL of 0.1 N hydrochloride acid and simulated intestinal fluid (SIF) without enzyme (pH 7.4, USP) maintained at 37±0.5° C. The basket rotation speed was maintained at 100 rpm. Samples were assayed by UV spectrophotometry at 444 nm for sodium ascorbate.

Confocal Laser Scanning Microscopy (CLSM) and Image Analysis

Observations were made with a Bio-Rad Lasersharp MRC-1024 attached to a microscope using a Zeiss Plan-Neofluar 10×/0.30 NA air lens. A 488-nm line of a krypton-argon laser and a laser power of 0.15 mW were used. The iris, black, gain control, and all other settings were kept constant during all experiments. Kalman for N=6 frames per Z level was set prior to initiation of Z series. Images were recorded at intervals of 5 μm in the Z direction.

Each set of photographs was evaluated using an image analysis system. The image was measured by determination of fluorescence intensity of sodium ascorbate in the film. The measurements were made in triplicate. Exactly the same size of image was determined for images at different sections.

Results of the Dissolution Test

To investigate the enteric properties of the tablets, a dissolution test was performed in 0.1 N HCl for 1 hour, and subsequently in SIF. The results showed that the 29.3% enteric-coated waxy cornstarch tablets had a good acidic resistance in 0.1 N HCl solution for at least 1 hour, while the lactose tablets failed the test. The waxy cornstarch-containing enteric tablets dissolved in SIF in less than 10 minutes. The lactose pellets gave no acidic resistance. As regards tablet performance, waxy cornstarch-containing tablets released the marker material slower than the lactose pellets.

### CONCLUSION

Clear differences were found in dissolution between the waxy cornstarch- and lactose-containing tablets. Waxy cornstarch contains almost entirely the polysaccharide amylopectin, with no amylose. Amylopectin is a branched D-glucose (alpha 1-6) chain. This chain also contains alpha 1-4, 1 of the 2 polysaccharides that make up a starch. The branched structure of waxy cornstarch with all its attached chains yielded a large molecule and gave steric hindrance. Obviously, this large branched molecule of waxy cornstarch is able to better control premature sodium ascorbate release from the tablets than when lactose is used as a cofiller (lactose is additionally more water soluble than waxy cornstarch).

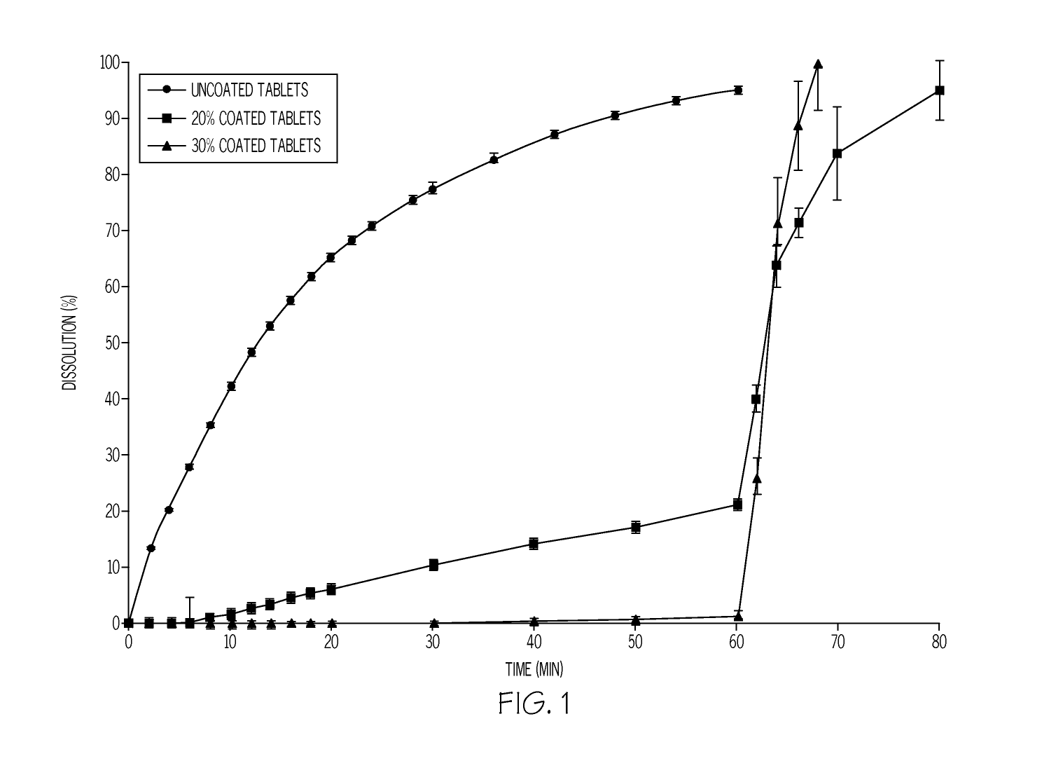

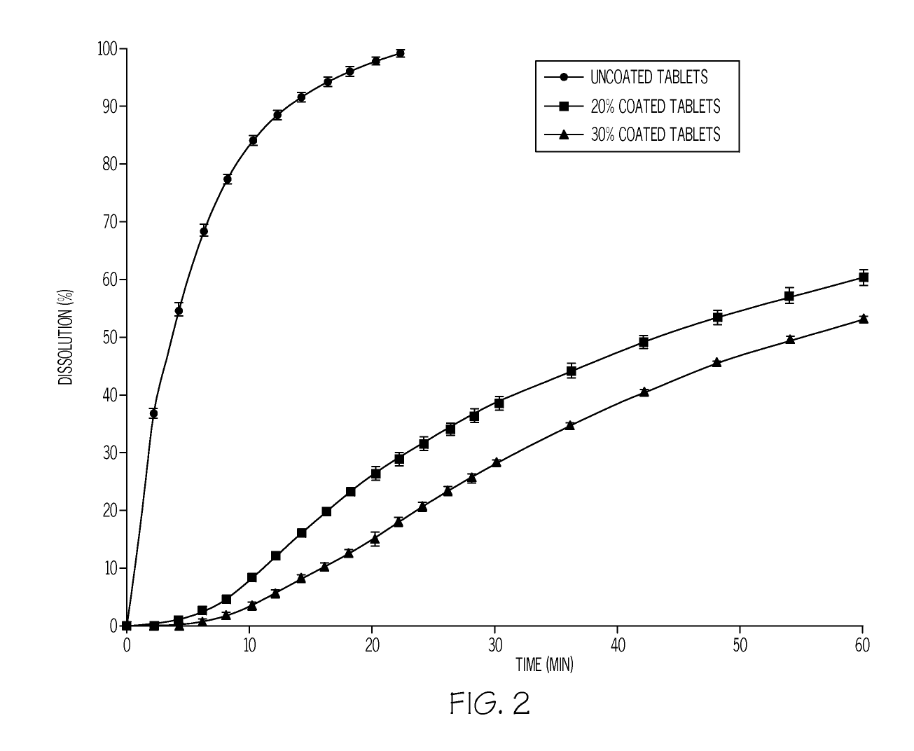

Lactose is a disaccharide that consists of galactose and glucose fragments bonded through a β-1→4 glycosidic linkage. Lactose's systematic name is β-D-galactopyranosyl-(1→4)-D-glucose. The reasons mentioned above explain why lactose-containing tablets dissolved faster and, consequently, were poorer candidates for than the waxy cornstarch tablets. FIG. 1 shows the dissolution profiles for sodium ascorbate tablets using waxy cornstarch as an enteric coating, which delays the dissolution of the tablets for a much longer period than does whey-derived lactose, as shown in FIG. 2.

While the description of the embodiments presented above has been described with reference to particularly preferred embodiments, it is recognized that similar advantages may be obtained by other embodiments. The foregoing description is intended to illustrate and not limit the scope of the invention, which is defined by the scope of the appended claims. It will be evident to those skilled in the art that various changes and modifications can be made without departing from the spirit and scope of the present invention, and all such aspects, advantages and modifications are within the scope of this invention and the following claims.

1. A composition for improving health and nutrition, the composition comprising:
an enteric coating comprising: a fatty acid, an oligosaccharide, and a vegetable gum.

2. The composition of claim 1, wherein the fatty acid comprises at least one fatty acid selected from the group consisting of:
oleic acid, lauric acid, linoleic acid, palmitoleic acid, caprylic acid, capric acid, myristic acid, palmitic acid, margaric acid, margaroleic acid, stearic acid, alpha-linoleic acid, arachidic acid, eicosanic acid, behenic acid, erucic acid, and combinations and mixtures thereof.

3. The composition of claim 1, wherein the fatty acid comprises oleic acid.

4. The composition of claim 1, wherein the oligosaccharide comprises at least one oligosaccharide selected from the group consisting of:
a fructo-oligosaccharide, a galacto-oligosaccharide, an inulin, and combinations and mixtures thereof.

5. The composition of claim 1, wherein the vegetable gum comprises at least one vegetable gum selected from the group consisting of: konjac root extract, gellan, xanthan, carrageenan, and combinations and mixtures thereof.

6. The composition of claim 1, wherein the vegetable gum comprises a natural vegetable gum, a modified vegetable gum, or combinations and mixtures thereof.

7. The composition of claim 6, wherein the natural vegetable gum comprises at least one gum selected from the group consisting of:
gum arabic, guar gum, agar, carrageenan gum, karaya gum, gum ghatti, locust agar, algin, pectin, xanthan gum, locust bean gum, gum tragacanth, tamarind gum, and combinations and mixtures thereof.

8. The composition of claim 6, wherein the modified vegetable gum comprises at least one gum selected from the group consisting of:
chelated agar; a pectin derivative; low-methoxyl pectin; high-methoxyl pectin; an alginate; a cellulose derivative; microcrystalline cellulose; methylcellulose; sodium carboxymethyl cellulose; carboxymethylcellulose; hydroxypropyl cellulose; hydroxypropyl methyl cellulose; sodium hydroxymethyl cellulose; carboxymethyl locust bean gum; gellan gum; carboxymethyl guar gum; and combinations and mixtures thereof.

9. The composition of claim 8, wherein the alginate comprises propylene glycol alginate.

10. The composition of claim 1, wherein the enteric coating comprises at least one soluble anionic fiber selected from the group consisting of: all forms of alginates, pectin, carrageenan, polygeenan, and gellan including protonated and salt forms; protonated alginic acid; and salts of alginic acid.

11. A method for stabilizing and protecting a food additive to enhance enteric nutrient absorption comprising the step of applying to the food additive an enteric coating composition comprising: a fatty acid, an oligosaccharide, and a vegetable gum.

12. A method for producing an enterically coated food article comprising: coating a food article with an enteric coating composition that is resistant to break down at a pH of 1 but begins to break down at a pH of greater than 7.

13. The method of claim 12, wherein the food article is a fruit or vegetable.

14. A method for producing a food additive for improving the shelf-life of a food article, wherein the method comprises the steps of:
(a) shredding a first food article;
(b) sanitizing the first food article;
(c) applying to the first food article a composition comprising: a fatty acid, an oligosaccharide, and a vegetable gum;
(d) freeze drying the first food article; and
(e) grinding the first food article into a powder to form a food additive.

15. The method of claim 14, wherein the method further comprises the step of:
(f) applying the food additive to a second food article.
